(19) United States
(12) Patent Application Publication
(10) Pub. No.: US 2025/0344293 A1
(43) Pub. Date: Nov. 6, 2025

(54) NON-METALLIC HEATING ELEMENT USING CARBON VEIL

(71) Applicant: Saudi Arabian Oil Company, Dhahran (SA)

(72) Inventor: Ghayth Mohammed Hassein Abed Abed, Dhahran (SA)

(21) Appl. No.: 18/655,923

(22) Filed: May 6, 2024

(51) Int. Cl. H05B 3/14; H05B 3/06; H05B 3/18; H05B 3/48

(52) U.S. Cl. CPC H05B 3/145; H05B 3/06; H05B 3/18; H05B 3/48; H05B 2203/016; H05B 2203/017; H05B 2203/021

(57) ABSTRACT

A non-metallic composite heating element assembly can be formed by winding a carbon veil onto a resin-rich structural layer before the resin-rich structural layer completely cures. The resin can wet through the carbon veil during formation, thereby bonding the carbon veil to the structural layer without the need for a separate and discrete adhesive layer. Other layers can also be formed, including a first insulating layer between the carbon veil and the first structural layer, a second insulating layer above the carbon veil, and a second structural layer formed above the second insulating layer. The carbon veil can include two busbars for supplying power to the carbon veil.

### TECHNICAL FIELD

The present disclosure applies to a non-metallic heating element that does not require a discrete adhesive layer. The non-metallic heating element can be integrated within composite material layers of pipes and tanks, as well as to form other structures with integrated heating.

### BACKGROUND

Nonmetallic pipes and tanks are widely used in chemical plants, oil and gas, water and sewerage systems, and other applications due to their corrosion resistance, strength, and durability.

### SUMMARY

The present disclosure describes techniques that can be used for heating a pipe or tank made from composite (non-metallic) materials using a non-metallic heating solution. In some implementations, a computer-implemented method includes the following.

Aspects of the embodiments are directed to a carbon veil heating element integrated within layers of a multi-layer composite material without a discrete adhesive layer contacting the carbon veil heating element; a first busbar electrically coupled to the carbon veil heating element, and a second busbar electrically coupled to the carbon veil heating element, the first busbar and the second busbar configured to establish a voltage across the carbon veil heating element.

Some implementations can also include a first structural layer formed by winding a resin-rich laminate reinforced with a glass surface veil, the carbon veil heating element formed above the first structural layer.

In some implementations, the carbon veil directly contacts the first structural element, the apparatus further including an insulating layer formed on the carbon veil heating element.

Some implementations also include an insulating layer formed between the first structural layer and the carbon veil heating element.

In some implementations, the insulating layer is a first insulating layer, the apparatus further including a second insulating layer formed on the carbon veil heating element.

In some implementations, the apparatus includes a protection layer.

Some implementations include a liner beneath the first structural layer.

Aspects of the implementations are directed to a method for forming a non-metallic pipe with an integrated heating element, the method including: forming a first structural layer by fiber winding a resin-rich glass surface veil, the resin-rich glass surface veil including a curable wet resin; before the wet resin has cured, applying a carbon veil above the first structural layer; bonding a first busbar to a first edge of the carbon veil; bonding a second busbar to a second edge of the carbon veil, the first busbar configured to conduct electrical charge to the second busbar through the conductive veil; forming an insulating layer on the carbon veil; and forming a second structural layer on the insulating layer.

In some implementations, the insulating layer is a second insulating layer, the method further including, prior to applying the carbon veil, forming a first insulating layer on the first structural layer before the resin has cured.

In some implementations, the first structural layer includes a glass surface veil with a C-glass composition in a range from 25-35 grams/square meter.

In some implementations, the first structural layer includes a resin-rich laminate with a thickness in a range from 0.25 to 0.5 millimeters.

Some implementations include forming a reinforced layer on the first structural layer prior to the resin curing, the reinforced layer including E-glass with a composition of 450 grams/square meter and with a resin content in a range from 60-80%.

In some implementations, the reinforced layer includes one of a chopped strand mat or tight weave glass fabric layer.

In some implementations, the resin-rich corrosion protection layer includes a C-glass veil with a C-glass composition in the range of 25 to 35 grams per square meter.

In some implementations, wherein the wet resin includes one of: a polyester resin based on bisphenol A or Isophthalic acid with temperature ranges from 50 to 75° C.; or a vinyl ester resin with temperature ranges from 75 to 100° C., or an epoxy resin with temperature ranges 80 to 200° C.

In some implementations, wherein the conductive carbon veil is wrapped in a spiral configuration.

In some implementations, wherein multiple conductive carbon veils are wrapped around the surface.

In some implementations, wherein first busbar is electrically connected to a power source and the second busbar is electrically connected to the power source, and wherein the conductive carbon veil is configured to pass current from the power supply from the first conductive strip to the second conductive strip.

Aspects of the embodiments are directed to a non-metallic composite hollow cylinder including: a first non-metallic structural layer; a carbon veil heating element formed above the first non-metallic layer, the carbon veil heating element including two electrodes; an insulating layer; and a second non-metallic structural layer; wherein the carbon veil heating element is bonded to the first non-metallic structural layer without an adhesive layer.

In some implementations, the insulating layer is a first insulating layer and resides between the first non-metallic structural layer and the carbon veil; and the non-metallic composite pipe further including a second insulating layer formed between the carbon veil and the second non-metallic structural layer.

Some implementations include a first busbar electrically coupled to a first edge of the carbon veil heating element; a second busbar electrically coupled to a second edge of the carbon veil heating element, the first edge opposite the second edge, the first busbar and the second busbar including a conductive material for establishing a voltage across the carbon veil heating element.

In some implementations, the first non-metallic structural layer includes: a surface layer formed from a chemically resistant material; and a structural reinforcement layer.

In some implementations, the insulating layer is an outer insulating layer that provides electrical insulation and strain relief for the carbon veil.

Some implementations include an inner insulating layer formed between the carbon veil heating element and first non-metallic structural layer.

Some implementations include a protective layer formed on the second non-metallic structural layer.

In some implementations, the hollow cylinder is a pipe.

In some implementations, the hollow cylinder forms a portion of a tank or boiler.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method/the instructions stored on the non-transitory, computer-readable medium.

The subject matter described in this specification can be implemented in particular implementations, so as to realize one or more of the following advantages. For example, by using a non-metallic heating solution surrounding the composite pipes or tanks, problems associated with the degradation of immersed electrical heating elements within the pipe or tank due to surface corrosion can be avoided. In addition, immersed heating element can also experience decreased heat transfer effectiveness due to sludge or other material build-up in the pipe or tank. The sludge can accumulate to the point where it can partly or fully incorporate the immersed heating element itself thereby reducing the contact surface between the immersed electrical heating element and the liquid. The non-metallic heating solution described herein can also be used for water and sewage pipelines, including those in cold regions. The liquid water contained in such pipes could undergo a phase change from liquid to solid in cold regions, thereby causing cracks that can lead to leaks and subsequent costly maintenance work for the pipeline. Pipelines used to transport heavy crude oil require heating in order to reduce liquid viscosity thereby improving the transportability and processability of the product. The non-metallic heating solution described herein can achieve the above advantages without experiencing degradation in heat transfer effectiveness or a degradation in the heating element itself.

Advantages of the present disclosure include, but are not limited, to corrosion-free heating method as the carbon veils are wrapped and sealed between layers of the composite materials thereby avoiding direct contact with the heated liquid. The heating element features improved damage resistance since local damages such as cuts or ruptures will not inhibit the electric current flow through the carbon veil. The use of the carbon veil and the application thereof to pipes or tanks can reduce idle time and maintenance costs, since the adoption of the carbon veil allows for achieving a greater heat exchange surface thereby overcoming issues related to sludge and sedimentation build up.

The methods of manufacturing described herein also have advantages of being able to apply non-metallic heating elements to a pipe or tank without the need for adhesive layers being added between the carbon veil and other intermediate layers of the composite pipe. This reduces the complexity and costs of the manufacturing process, while still facilitating the use of non-metallic heating solutions to heat the pipe or tank externally.

The conductive carbon veil can be easily wrapped around objects of various geometry using a filament winding process or applied by hand. The advantage of using carbon veil as a heating element is that it constitutes a corrosion free heating method as the carbon veils are wrapped and sealed between layers of the composite materials thereby avoiding direct contact with the heated liquid. In addition, the heating efficiency is improved as sludge or sedimentation build do not hinder the heat transfer.

Another advantage of using a conductive carbon veil is the reduce energy consumption compared to a conductive heating element, as the carbon veil has a larger heated surface area run alongside the wall of the pipe or tank.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIGS. 1A-C are schematic illustrations of example heating element assembly layers and structures in accordance with some implementations of the present disclosure.

FIGS. 2A-B are schematic cross-sectional illustrations of example heating element assembly layers integrated into a reinforced thermosetting resin (RTR) pipe in accordance with some implementations of the present disclosure.

FIGS. 2C-D are schematic cross-sectional illustrations of example heating element assembly layers integrated into a reinforced thermoplastic (RTP) pipe in accordance with some implementations of the present disclosure.

FIGS. 3A-B are schematic illustrations of example heating element assembly layer configurations on a pipe in accordance with some implementations of the present disclosure.

FIGS. 4A-B are schematic illustrations of example heating element assembly layer configurations on a tank in accordance with some implementations of the present disclosure.

FIGS. 5A-D are schematic illustrations of zone heating configurations on a tank in accordance with some implementations of the present disclosure.

FIG. 6 is a process flow diagram for manufacturing non-metallic pipe and constructing the heating element layers in accordance with some implementations of the present disclosure.

FIG. 7 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements. Drawings are not to scale.

### DETAILED DESCRIPTION

The following detailed description describes techniques for a heating element that includes a carbon veil and without a discrete adhesive layer, and methods for constructing the same. Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

Aspects of the present disclosure are directed to construction of a heating element for non-metallic pipes and tanks that use randomly oriented non-woven carbon fibers in a carbon veil embedded as one of the layers of a multi-layer composite material making up the heating element. The carbon veil (also referred to as a carbon mat) is heated up through the passage of electric current. The amount of heat being delivered depends directly on the amount of power being supplied by a power supply. A thermostat controller can be adopted in order to maintain the liquid within a predetermined temperature range.

Commonly heated tanks use immersed electrical elements to heat the contained liquid. Several issues are associated with the commonly used electrical heated elements as for example, degradation of the electrical heating element due to surface corrosion and/or a decrease in the heat transfer effectiveness of the heating element due to sludge build up in the tank or on the heating element. The sludge might accumulate to the point where it can partly or fully incorporate the heating element itself thereby reducing the contact surface between electrical heating element and liquid.

Examples of applications that use heated pipes include water and sewage pipelines in cold regions. In this case the liquid water contained in such pipes could undergo a phase change from liquid to solid thereby causing cracks that can lead to leaks and subsequent costly maintenance work for the pipeline. Another example involves pipelines used to transport heavy crude oil require heating in order to reduce liquid viscosity thereby improving the transportability and processability of the product.

The most commonly heating devices adopted in order to heat liquids within containers use resistance wires (called heat tracing). Such heating devices generally lead to high energy consumption rates. Techniques described herein use a heating element that includes a conductive veil such as carbon veil embedded within composite insulation layers. The heating solution based on the adoption of a carbon veil embedded in an insulating composite material increases the life expectancy of the tank/boiler since the heating element is not affected by corrosion as is the case for the traditional solutions available on the market. In addition, the problem of reduced heating efficiency due to sludge build up in the bottom of the tank and on the heating element is also overcome since the heating device is distributed along a wider surface.

The heating element of the present disclosure facilitates a large contact surface between the liquid and the heating element accelerating the heating process of the fluid. The convection heat transfer formula shows that the heat transfer depends on the exposed surface area and the difference in temperature (as shown in Equation 1):

$$Q = hA Δ T \qquad Equation 1$$

where Q=the rate of heat transfer, h=convection heat transfer coefficient, A=the exposed surface area, and ΔT=the difference in temperature.

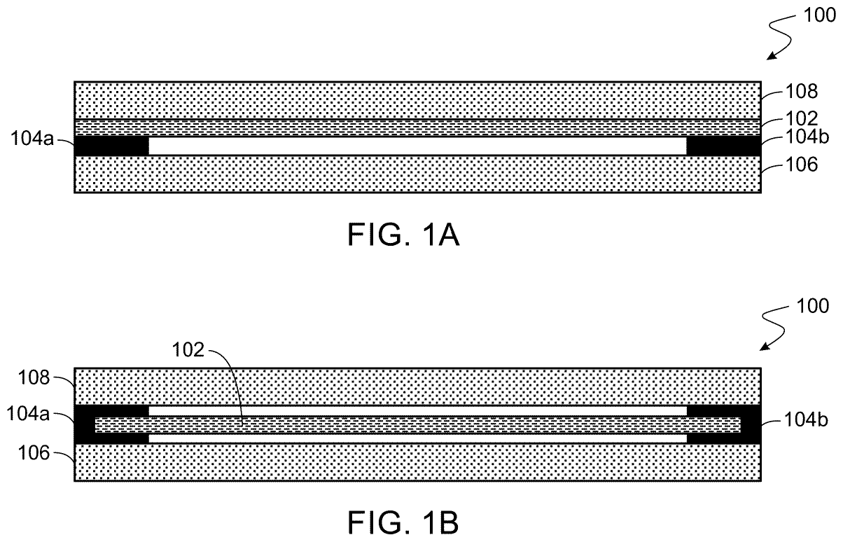

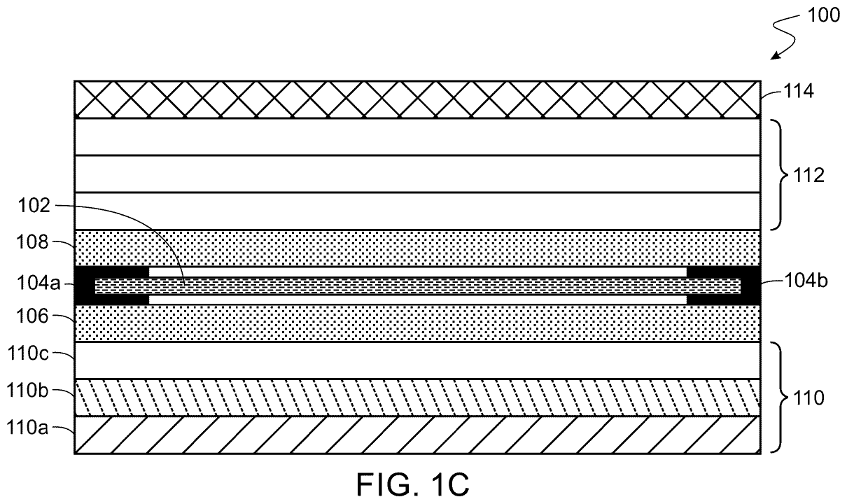

FIGS. 1A-C are schematic illustrations of example heating element assembly 100 layers and structures in accordance with some implementations of the present disclosure. The heating element assembly 100 uses an electrically conductive carbon veil 102 (or carbon veil 102 for short) of randomly oriented fibers as a heating element. The electrically conductive carbon veil 102 can be formed between two electrical insulation layers, first electrical insulation layer 106 and second electrical insulation layer 108, as shown in FIGS. 1A-C. Insulation layers 106 and 108 can include chopped strand mat, woven light weight glass (such as e-glass or c-glass), Kevlar, or polyester fabric with tight weave. The insulating layers 106 and 108 prevent electrical contact between the carbon veil 102 and other structural layers. In addition, insulating layer 108 can provide additional structural reinforcement, such as in cases of forming a non-metallic pipe. The insulating layer 108 can provide some stress relief for the carbon veil 102 when forming the non-metallic pipe. In some embodiments, the carbon veil 102 can be formed directly on other layers, like structural layers, without the first insulating layer 106. Other examples of structures that can be made with an integrated heating element assembly like that shown in FIGS. 1A-C include tanks and boilers, and other similar structures.

In other embodiments, the heating element assembly 100 can include a carbon veil 102 as a heating element without the insulating layer 106 and 108. For example, in applications where electrical isolation is not required, and where structural reinforcement is not required from one of the insulation layers, the carbon veil 102 can be formed directly on one of the other layers. Example applications include, but are not limited to, showers, bathtubs, hot tubs, etc.

Returning to the implementation shown in FIG. 1A, the heating element assembly 100 includes a first conductive material 104a and a second conductive material 104b, which serve as electrodes or busbar. Conductive material can be copper tape. The first conductive material 104a can be formed or placed on one edge of the carbon veil 102; and the second conductive material 104b can be formed or placed on another, opposite edge of the carbon veil 102. A conductive adhesive may be applied between the carbon veil 102 and the first conductive material 104a and second conductive material 104b to ensure secure electrical and physical contact. The conductive adhesive helps in maintaining consistent resistance and avoid any hot spots between the conductive busbar and the carbon veil 102. By passing electrical current through the carbon veil 102 across the first conductive material 104a and the second conductive material 104b, heat is generated. The temperature can be controlled by the amount of electric power applied. As shown, the conductive busbars resides between the first and second insulating layers.

The conductive busbar could be placed below or above the veil or could be folded on the edges of the conductive veil. In FIG. 1A, the conductive busbar is placed below (or on one lateral side of the electrically conductive veil 102). In FIG. 1B, the conductive busbar is shown to be folded on the edges of the carbon veil 102. Folding the conductive material around the edges of the electrical conductive veil 102 can secure the carbon veil 102 to the conductive material and prevent resin from other layers to inter and affect the contact between the busbar and the conductive carbon veil 102.

The carbon veil 102 is placed closer to the surface that requires heating. FIG. 1C illustrates that the carbon veil 102 is not in the middle of the layers and is closer to inner layer 112. This makes sure the heat transfer to layer 112 is much faster than that though the layer of 110. The thickness of the structural layers can be selected based on the internal pressure requirements for the pipe or tank, or based on other mechanical characteristics. Note, however, that the carbon veil 102 can be formed and can reside at any relative layer position in the heating element device 100. For example, the carbon veil 102 can be formed and can reside closer to the middle or upper layers of the heating element 100.

In FIG. 1C, the heating element assembly 100 is shown to include first structural layer 110. First structural layer 110 includes three sub-layers. First, an inner surface layer 110a of 0.25 mm to 0.5 mm smooth resin rich (about 90% resin content) laminate reinforced with glass surface veil is provided to provide optimum corrosion resistance and a smooth finish with low friction factor. C-glass can be used as part of this inner surface layer 110a. A chemical resistant layer 110b can be provided before creating a structural strength layer 110c. Some specifications may mandate the chemical resistant layer 110b, which can be made of a chemical resistant resin-rich (about 70%-80% resin content) liner ranging having a prescribed thickness (e.g., thickness of 2.5 mm upwards) in the form of chopped strand mat (CSM), which limits chemical permeation to the structural layer. A woven roving glass layer could be wound on top of the CSM layer, as part of the chemical resistant layer 110b. A first structural strength layer 110c is provided using glass fiber roving, such as e-glass. The fiber glass roving are wrapped to a desired pipe wall thickness.

Note that for certain applications, not all of the sub-layers of the first structural layer 110 need to be used. For example, for a pipe, tank, or boiler, it is preferable to include the inner surface layer 110a of a chemical-resistant material. However, for applications that do not require chemical resistance, this inner surface layer 110a does not need to be used; or, the inner surface layer 110a can be made of a different type of material. Generally, the first structural layer should include at least some resin-rich material for bonding the carbon veil 102, so that no discrete adhesive layers are required to form the heating element assembly 100.

Optionally, a first insulation layer 106 is provided. The first (and second) insulation layers can be formed from chopped strand mat material and or a surface layer material, which are both described in more detail below.

Then the carbon veil layer (carbon veil 102) is formed around the resulting tube in spiral way. The resin squeezed from the first structural layer impregnates the carbon veil 102 and no need for adhesive or bonding resin. The busbars 104a-104b or other electrode implementation can be added either before, after, or during the application of the carbon veil 102.

Another (a second) insulation layer 108 may be added to on the top of the carbon veil 102 to avoid damage caused by high tension applied on the glass roving fibers of the second structural layer. This second insulation layer 108 is also optional. The second insulation layer 108 can also be made from an electrically insulating material, similar to the first insulation layer 106.

A second structural layer 112 is applied. The second structural layer 112 can be of glass fiber roving and chopped strand mat. As shown in FIG. 1C, the second structural layer 112 can be formed from one or a plurality of sub-layers, made from e-glass fiber roving, woven roving and CSM, for example.

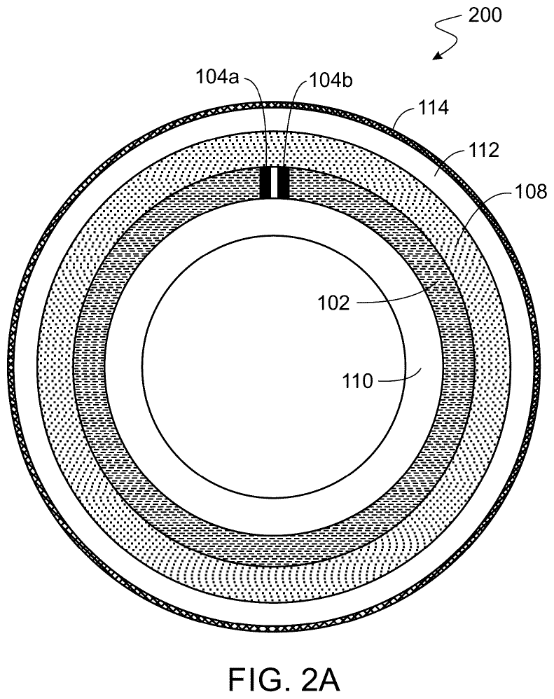

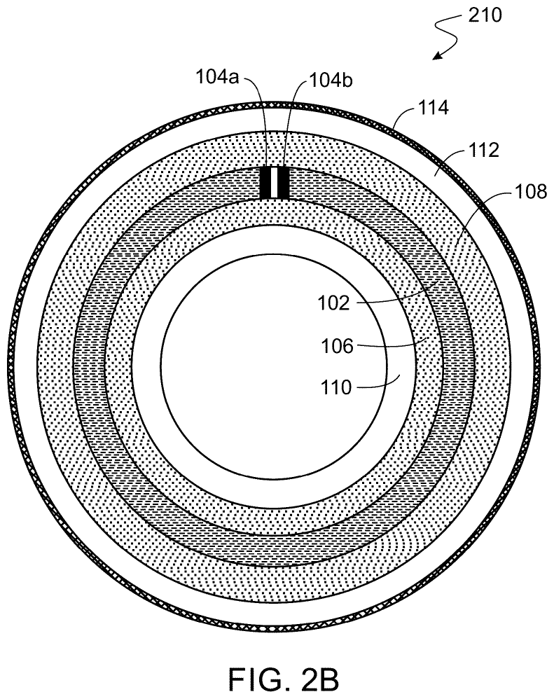

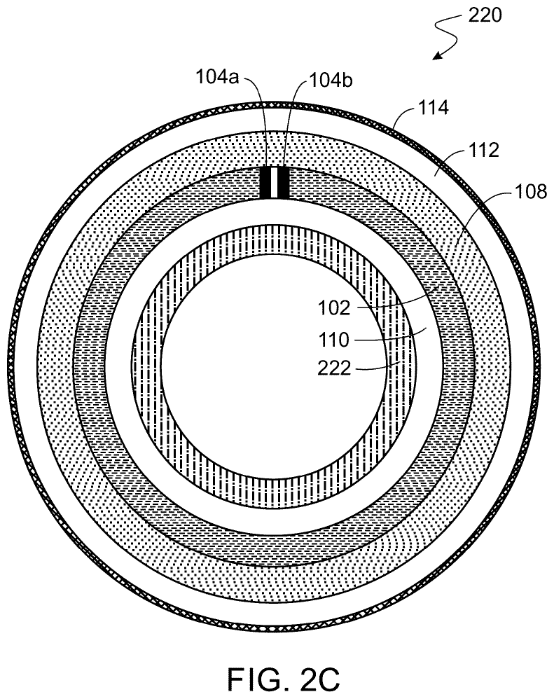

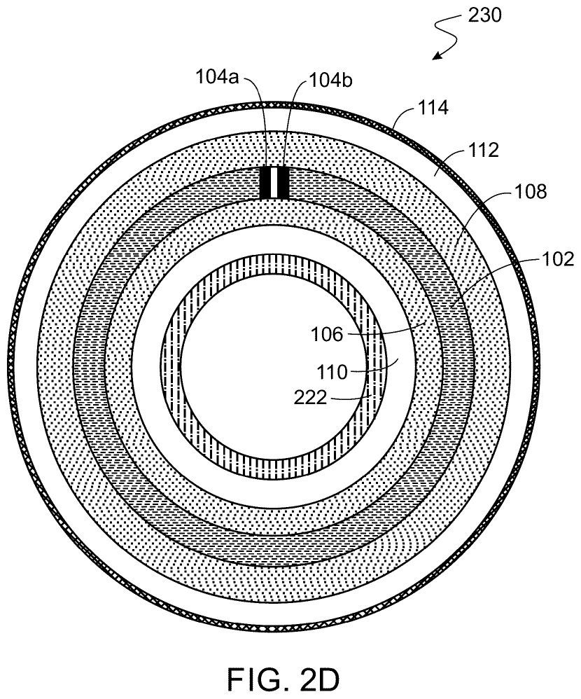

FIG. 1C shows that the heating element assembly 100 includes a protection layer 114 that is applied to provide protection against, e.g., weather, fumes, spillage and ultraviolet radiation, and increases the design life of the pipe. This protection layer 114 is shown in FIGS. 2A-D. The protection layer 114 can be made from resin rich surface layer, gel coats, polyethylene jacket, rubber, or other material.

The conductive carbon veil 102 is wrapped on the top of the inner structural layer 110 while the resin is still not fully cured. This process allows resin from the structural layer to wet out through the conductive carbon veil 102, which causes the carbon veil 102 to bond to the structural layer and become part of it without the need for an additional adhesive layer. By doing this process, the conductive carbon veil 102 essentially becomes integrated into the resulting pipe. This process takes place with or without the intermediate insulating layer 106. In fact, the intermediate insulating layer 106 can be formed while the resin for the inner structural layer(s) is still curing. This way, both the insulating layer 106 and the carbon veil 102 become bonded to the inner structural layer and integrated into the pipe. Likewise, layer formed above the carbon veil 102 can also be bonded without an adhesive, such as the second insulating layer 108.

The outer structural layer 112 is formed using a resin-rich glass roving fiber layer or roving tape is also formed. Because the outer structural layer 112 is resin-rich, it can bond to the lower layers without an adhesive. Any further upper layers are formed before the resin is cured, for the same reason (to avoid an adhesive layer). For example, a protection layer can be formed or applied above the outer structural layer 112.

The busbars can be copper conductive strips or tapes are adhesively bonded or mechanically fastened to the carbon veil.

FIGS. 2A-B are schematic cross-sectional illustrations of example heating element assembly layers integrated into a reinforced thermosetting resin (RTR) pipe 200 in accordance with some implementations of the present disclosure. In FIG. 2A, the pipe 200 is formed with an integrated carbon veil heating element 102 directly on the first (or inner) structural layer 110 (i.e., without an intervening insulating layer). The busbars 104a and 104b are formed on the edge of the carbon veil heating element 102 and are proximate to one another.

The insulating layer 108, therefore, is formed on the carbon veil heating element 102. The second (or outer) structural layer 112 is formed on the second insulating layer. A protection layer 114 is formed on the second structural layer 112. The protection layer can protect against weather, ultraviolet and mechanical impact added to increase the design life of the pipe. In FIG. 2B, the RTR pipe 210 includes an intervening (or first) insulating layer 106 between the first structural layer 110 and the carbon veil heating element 102.

In the case of an RTR pipe 200 and 210, the pipe does not include a thermoplastic liner. FIGS. 2C-D are schematic cross-sectional illustrations of example heating element assembly layers integrated into a reinforced thermoplastic (RTP) pipe in accordance with some implementations of the present disclosure. The RTP pipes 220 and 230 of FIGS. 2C and 2D, respectively, are similar to RTR pipes 200 and 210, with the exception of the addition of the thermoplastic liner 222.

In FIG. 2C, the RTP pipe 220 includes a thermoplastic liner 222. The first structural layer 110 is formed around the thermoplastic liner 222. The RTP pipe 220 does not include an intervening insulating layer between the first structural layer 110 and the carbon veil heating element 102. In FIG. 2D, the RTP pipe 230 includes a thermoplastic liner 222. The RTP pipe 230 also includes an intervening insulating layer 106 between the first structural layer 110 and the carbon veil heating element 102.

The following provides a list of materials that can be used to form the various layers of the pipe:

Glass roving fibers: This type of reinforcement material is used in the structural layers of filament wound piping. The high glass content (low resin content) provides high strength in the direction of the fiber. Continuous roving should not be exposed to chemical environments as they could allow wicking of chemicals into the laminate.

Chopped strand mat (CSM): This material is non-woven and includes short glass fiber typically (0.5-2 inch long) that are randomly orientated. This layer provides good chemical resistance due to the high resin content. As the glass fibers are not continuous, it is difficult for chemicals to penetrate the laminate by following along the fiber. Chopped strand mat is available in a variety of weights with 150-300 gram per square meters the most commonly utilized. The chopped strand mat can be used as a reinforcement layer, and also as an insulation layer.

Woven roving glass tape: This type of reinforcement material utilizes glass fibers orientated in the 0° & 90° directions. Unlike chopped stand mat, the fibers of the woven roving glass tape are continuous, and no binder is used to hold the arrangement together. Woven roving glass tape lacks the chemical resistance of chopped strand mat due to the continuity of the glass fibers and high glass content; however; woven roving glass tape does offer increased strength. Woven roving layers should always be preceded and followed by chopped strand mat layers to maximize adhesion.

Surface layer: This glass surface veil is applied to provide chemical and corrosion resistance layer. As an example, a resin-rich laminate reinforced with glass surface veil can include 90% resin content. The resin-rich laminate can be 0.25-0.5 mm. The glass veil can be C-glass (C: referee to chemical resistance glass veil) with up to 25-35 g/m2 of C-glass. The surface layer can also be used as an insulation layer.

To protect the electrical conductive carbon veil layer form chemical attach or damage caused by the second structural layer, the insulation layer 106 & 108 could be made from one of these layers (CSM and surface layer) or both layers.

The carbon veil 102 is an electrically conductive carbon-fiber-based material. From Table 1, there are various types of carbon veils with different weights and electrical properties. Note that the surface resistance of the carbon veil is reduced with the increase of the weight of the carbon veil. The most conductive type of veil is copper and nickel coated carbon veil (20444A/B).

TABLE 1
Surface resistance of different types of carbon veils

| | | | Copper & |
|---|---|---|---|
| | | Nickel | Nickel |
| | | Coated | Coated |
| | Carbon | Carbon | Carbon |
| | (20301A) | (20404E) | (20444A/B) |
| Areal | Surface | Surface | Surface |
| Weight | Resistivity | Resistivity | Resistivity |
| (g/m²) | (Ω/sq) | (Ω/sq) | (Ω/sq) |
| 4 | 13 | 3.6 | 0.6 |
| 10 | 8 | 1.5 | 0.3 |
| 17 | 5 | 1.3 | 0.2 |
| 34 | 3 | 1.0 | 0.2 |
| 50 | 2 | 1.0 | 0.1 |
| 80 | 2 | 0.8 | 0.1 |

As can be seen from the table above, the copper and nickel coated carbon veil not only has the lowest surface resistivity, but also has a surface resistivity that is relatively consistent between areal weight. This allows for more consistent heating applications, more control over temperature control, and tolerance of different weights. For example, copper and nickel coated carbon veil with a weight of 32 g/m² can provide surface resistivity for controlled heating of the pipe.

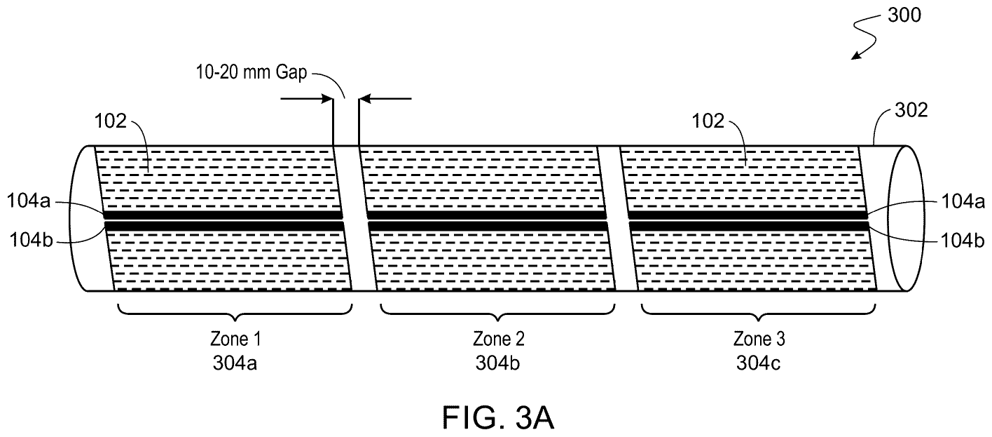

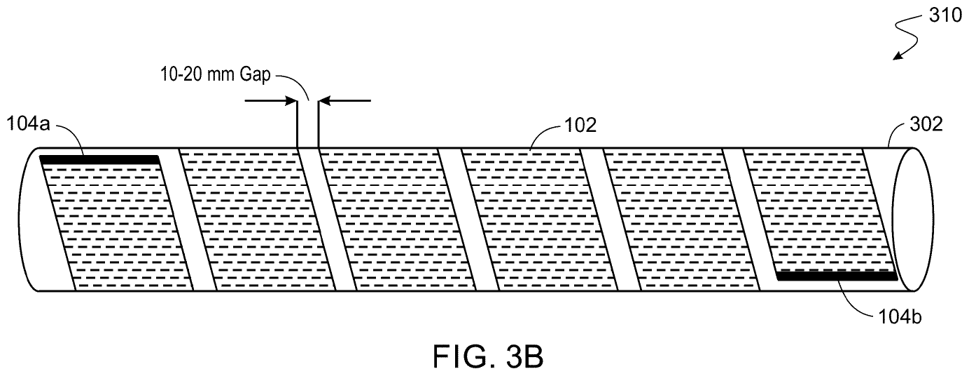

FIGS. 3A-B are schematic illustrations of example heating element assembly layer configurations on a pipe in accordance with some implementations of the present disclosure. In FIGS. 3A-B, only the carbon veil 102 is shown for simplicity, but it is understood that one or more other layers are also wrapped on the first structural layer of the pipe. FIG. 3A is a schematic illustration 300 of a first example of a heating element assembly 100 wrapped around a pipe 302. In FIG. 3A, multiple heating element assemblies (and thus, multiple carbon veils 102) are wrapped around the pipe 302. Each carbon veil 102 can be electrically connected to a set of electrodes, such as first conductive material 104a and second conductive material 104b. Each carbon veil 102 is wrapped on the first structural layer of the pipe 302 following a spiral trajectory. Each heating element assembly is individually controllable. Therefore, the pipe 302 can be divided into temperature zones, where each zone can be controlled to a specific temperature. This structure is useful for pipes that are partially buried, for example, and some of the pipe is exposed to a different environment or where the heat of the fluid inside the pipe needs to be heated or cooled gradually while passing these zones. In the example shown in FIG. 3A, there are three zones: Zone 1 304a, Zone 2 304b, and Zone 3 304c. Each zone can be controlled via a temperature sensor connected to a power source. One or multiple power sources can be used in conjunction with other power electronics, not shown here. The spiral trajectory is formed with a defined gap between the edge of each heating element assembly or carbon veil 102. The gap shown in FIGS. 3A-3B is generally around 10 to 20 mm and object diameters.

FIG. 3B is a schematic illustration 310 of a second example of a heating element assembly 100 wrapped around a pipe 302. In FIG. 3B, a single carbon veil 102 is formed around the first structural layer the pipe 302. Similar to FIG. 3A, the carbon veil 102 (really, the heating element assembly) is wrapped on the structural layer of the pipe in a spiral formation while maintaining a gap between the edges of the heating element assembly. The length of pipe wrapped with the heating element assembly can be determined by the power required and type of pipe, for example RTR pipe (202) normal length is about 12 meter long and RTP pipe (212) is spoolable and can reach several kilometers in length. By wrapping multiple pipe segments with different heating element assemblies, each pipe segment can be controlled to a desired temperature.

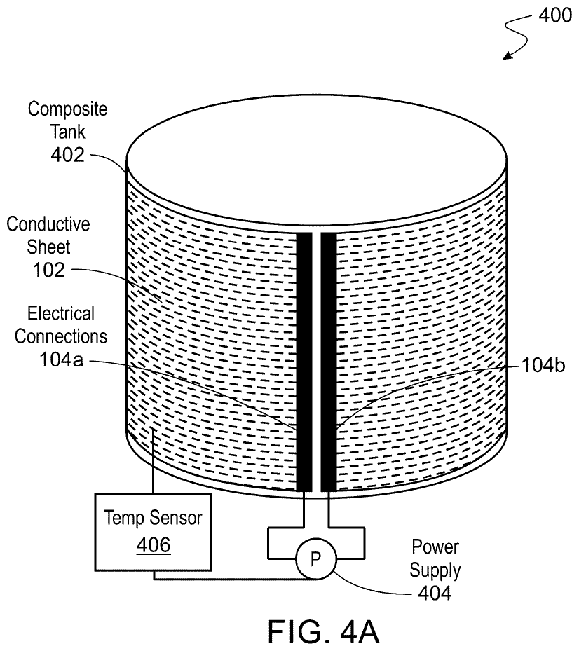

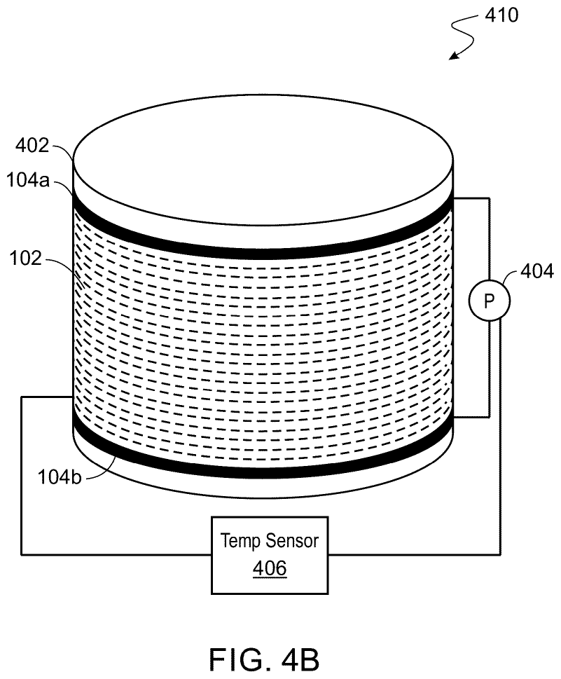

FIGS. 4A-B are schematic illustrations of example heating element assembly layer configurations integrated into a tank in accordance with some implementations of the present disclosure. FIG. 4A is a graphical illustration 400 a tank 402 with a heating element assembly (shown here only as the carbon veil 102) integrated in the tank in a first orientation. In the first orientation, the carbon veil 102 and other elements are formed around the tank so that the each electrode/busbar (first conductive layer 104a and second conductive layer 104b) are adjacent (though not touching). FIG. 4A shows the power supply 404 that is used for providing current to the electrodes (first conductive layer 104a and second conductive layer 104b) that causes the carbon veil 102 to heat. The carbon veil 102 is wrapped around the cylindrical surface. The electric conductive electrode/busbar (first conductive layer 104a and second conductive layer 104b) are oriented along the vertical direction. A temperature sensor 406 can be used to measure the temperature of the carbon veil 102 (or the temperature of the tank 402 itself, or the temperature of the fluid inside the tank). The temperature sensor 406 can be communicably coupled to the power supply 404. The power supply 404 can adjust the electrical signal (voltage or current) to the first conductive electrode/busbar 104a and second conductive electrode/busbar 104b to control (change or maintain) the heat output from the carbon veil 102.

FIG. 4B is a graphical illustration 410 a tank 402 with a heating element assembly (shown here only as the carbon veil 102) applied on the tank in a second orientation. In the case of a heated tank, the tank cylindrical surface includes carbon veil 102 with other heating element assembly layers. The electrodes/busbars (first conductive layer 104a and second conductive layer 104b) are not adjacent but are on distal edges of the carbon veil 102.

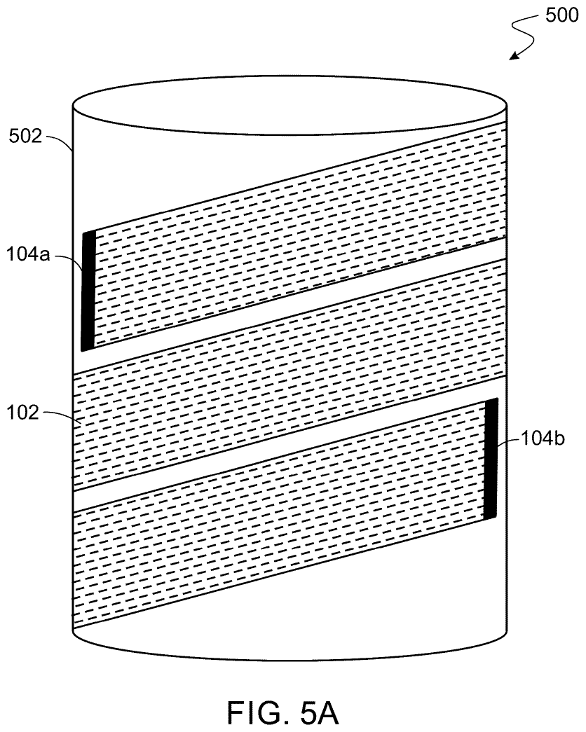

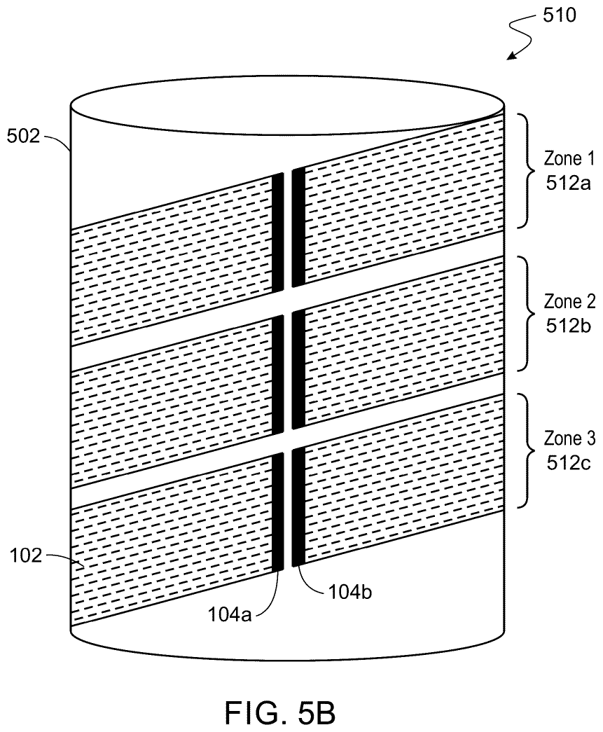

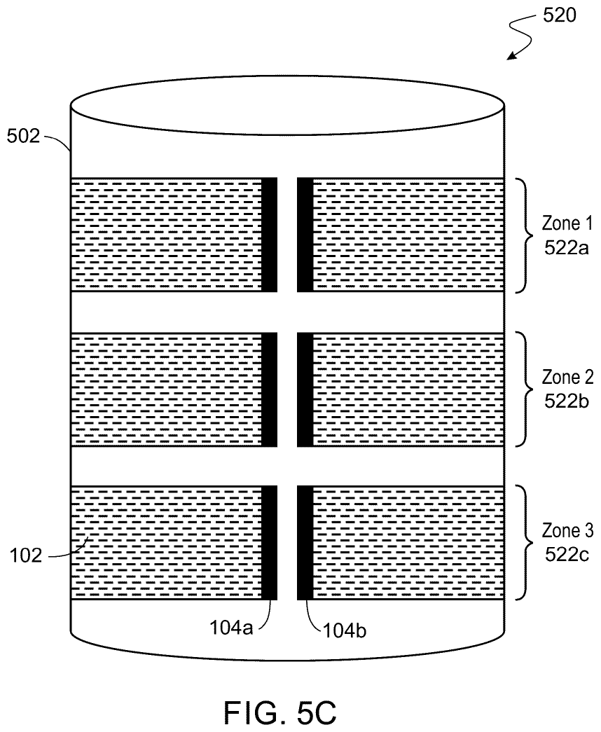

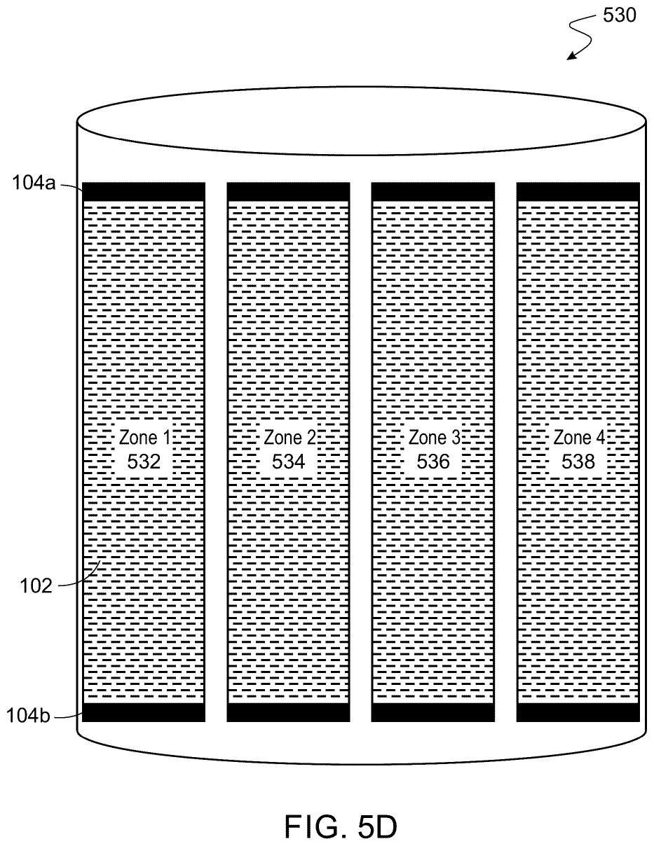

FIGS. 5A-D are schematic illustrations of zone heating configurations on a tank in accordance with some implementations of the present disclosure. In FIGS. 5A-B, the carbon veil 102 is wrapped around the cylindrical surface following a spiral trajectory. In FIG. 5A, the graphical illustration 500 shows that a single carbon veil 102 is wrapped around the tank 502; whereas in FIG. 5B, the graphical illustration 510 shows multiple carbon veils 102 wrapped around discrete portions of the tank 502. In FIG. 5B, the tank can be sectioned into zones, such as Zone 1 512a, Zone 2 512b, and Zone 3 512c. Each zone is individually controllable so that can be switched off based on the fluid level in the tank.

FIG. 5C is a graphical illustration 520 of a tank 502 with horizontally aligned (or substantially horizontally aligned) carbon veils 102. In FIG. 5C, the tank can be sectioned into zones, such as Zone 1 522a, Zone 2 522b, and Zone 3 522c. Each zone is individually controllable and can be switched off based on the fluid level in the tank.

FIG. 5D is a graphical illustration 530 of a tank 502 that includes multiple vertically oriented heating element assemblies. The heating element assemblies can cover part or all of the tank 502, with some gaps between each heating element assembly. Each heating element assembly can constitute a zone. In FIG. 5D, four zones are shown: Zone 1 532, Zone 2 534, Zone 3 536, and Zone 4 538. Each zone is individually controllable.

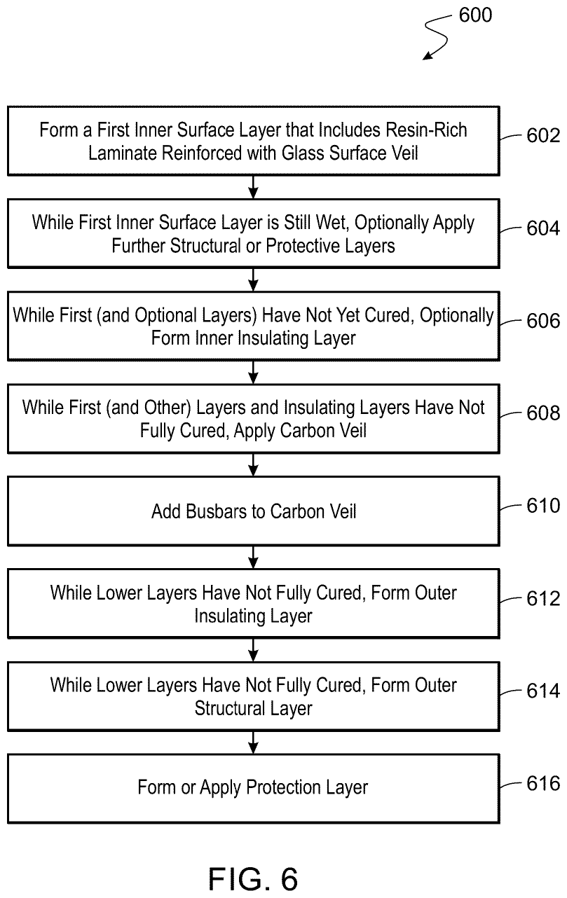

FIG. 6 is a process flow diagram for constructing heating element layers to a non-conductive pipe surface in accordance with some implementations of the present disclosure. For clarity of presentation, the description that follows generally describes method 600 in the context of the other figures in this description. However, it will be understood that method 600 can be performed, for example, by any suitable system, environment, software, and hardware, or a combination of systems, environments, software, and hardware, as appropriate. In some implementations, various steps of method 700 can be run in parallel, in combination, in loops, or in any order. A pipe section can be secured to the mandrel for applying the various layers of the heating element assembly.

Nonmetallic pipes and tanks are widely used in chemical plants, oil and gas, water and sewerage system due to its corrosion resistance, strength and durability. For example, reinforced thermosetting resin (RTR) pipes include of glass fiber reinforcements, thermosetting resin and additive. These pipes are manufactured using filament winding process where the dry glass fiber roving or roving tape is wetted with the resin and wound on a mandrel in a specific pattern until the required structural thickness is achieved. The fiber orientations are specified based on the structural requirements. As an example, the winding angle can be 54°+2°, though other angles are also contemplated. This winding angle provides optimum axial and hoop strength to an RTR pipe. To get better corrosion resistance, a resin rich (about 90% resin content) inner layer is recommended. This can be achieved normally by applying a layer with a hand lay-up process or low fiber tension to make sure the resin content is high near the inner surface.

At 602, a first surface layer of resin-rich laminate reinforced with glass surface veil is formed. The pipe can be formed, for example, using a filament winding machine and process, though other composite pipe forming techniques can also be used. One of the advantages of this process is that existing tools can be used to form the pipe or tank with the integrated heating element and no adhesive layer.

The first surface layer or first structural layer is formed as the inner layer of the pipe, which can provide chemical and corrosion resistance, as well as general formation of the pipe. As an example, a resin-rich laminate reinforced with glass surface veil can include 90% resin content. The resin-rich laminate can be 0.25-0.5 mm. The glass veil can be C-glass with up to 25-35 g/m² of C-glass.

From 602, method 600 proceeds to 604.

At 604, optionally, another reinforced laminate layer with resin and E-glass can be formed on the first surface layer. Another reinforced layer of E-glass (150-300 g/m²) wound on the inner layer with a resin content of about 60-80% by weight. The thickness of this layer is about 2.5 mm upwards in the form of chopped strand mat which limits chemical permeation to the structural layer. This reinforcement layer is formed while the first structural layer has not yet cured. The structural layer of glass fiber roving or roving tape is added to desire thickness and to meet the internal pressure requirement. Likewise, any additional optional layers should conform to desired thicknesses and pressure requirements for the pipe.

From 604, method 600 proceeds to 606.

At 606, optionally, and before the first structural layer has cured and before any optional intermediate layers have cured, a first insulating layer (glass surface veil or chopped strand mat) is formed.

From 606, method 600 proceeds to 608.

At 608, a dry conductive carbon veil is wrapped on top of structural layer before resin fully cures. This allows access resin from the structural layer wetting out the conductive carbon veil and adhered to the structural layer and become part of it.

From 608, the method 600 proceeds to 610.

At 610, the copper conductive busbar as strips or tapes are adhesively bonded or mechanically fastened to the carbon veil. The conductive carbon veil can be applied by hand or using a filament winding system.

From 610, method 600 proceeds to 612.

At 612, a chopped strand mat or tight weave glass fabric layers (20-100 g/m²) are formed on the top of the carbon veil to provide protection layer before the final glass fiber roving layer or roving tape is applied.

From 612, method 600 proceeds to 614.

At 614, a final glass roving fiber layer or roving tape is wound to required thickness.

From 614, the method 600 proceeds to 616.

At 616, a protection layer against weather, ultraviolet and mechanical impact is added to increase the design life of the pipe.

After 616, method 600 can stop.

Common glass fiber types are E-glass and C-glass. E-glass is used for structural layers because of its high strength. C-glass has good chemical resistance hence its used as corrosion barrier. The commonly used resin for manufacturing pipes and tanks selected based on service temperature, chemical resistance, cost. For example: the service temperature for polyester resin based on bisphenol A or Isophthalic acid ranges 50-75° C., vinyl ester resin ranges 75-100° C., and epoxy resin ranges 80-200° C.

By applying the carbon veil to the wet surface of the structural layer makes sure the carbon veil adheres completely within the structural layers and become part of it. This prevents any delamination between the structural layers and the carbon veils due to thermal stresses cause by heating and cooling cycles.

Generally, this disclosure contemplates a carbon veil heating element integrated into another composite structure without the need for an adhesive layer. This disclosure provides example implementations for pipes and tanks that include integrated carbon veil heating elements. However, other applications and use cases are within the scope of this disclosure. For example, the integrated carbon veil can be applied to other structures that are formed through similar processes, including but not limited to, composite tiles, such as roof tiles, or heated bathtubs, hot tubs, or swimming pools that are made from composite materials. Another example implementation can also include a boiler. An integrated heating element as described herein, that is resistant to corrosion, can also be applicable to heating aquatic based applications, such as aquariums, where carbon veil heating element can be integrated within glass fiber or other composite layers of the tank.

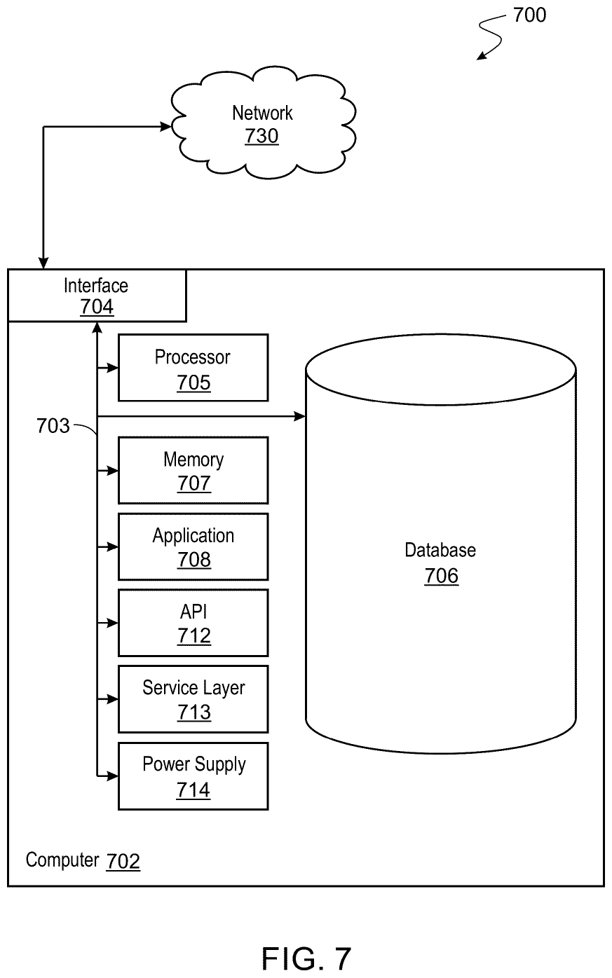

FIG. 7 is a block diagram of an example computer system 700 used to provide computational functionalities associated with described algorithms, methods, functions, processes, flows, and procedures described in the present disclosure, according to some implementations of the present disclosure. The illustrated computer 702 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 702 can include input devices such as keypads, keyboards, and touch screens that can accept user information. Also, the computer 702 can include output devices that can convey information associated with the operation of the computer 702. The information can include digital data, visual data, audio information, or a combination of information. The information can be presented in a graphical user interface (UI) (or GUI).

The computer 700 can be electrically connected or otherwise in communication with temperature gauges for measuring temperatures along pipe sections. The computer 700 can also be electrically connected or otherwise control power delivered to the heating elements. The computer 700 can use temperature information to control the temperature of the heating elements so as to control the temperatures of the pipe sections. The computer 700 can be preprogrammed with temperature ranges ideal for the pipe sections, and can automatically switch on or off the heating elements to maintain or obtain a desired temperature or temperature range. The computer 700 can include programs to automatically read temperature and control the heating elements.

The computer 702 can serve in a role as a client, a network component, a server, a database, a persistency, or components of a computer system for performing the subject matter described in the present disclosure. The illustrated computer 702 is communicably coupled with a network 730. In some implementations, one or more components of the computer 702 can be configured to operate within different environments, including cloud-computing-based environments, local environments, global environments, and combinations of environments.

At a top level, the computer 702 is an electronic computing device operable to receive, transmit, process, store, and manage data and information associated with the described subject matter. According to some implementations, the computer 702 can also include, or be communicably coupled with, an application server, an email server, a web server, a caching server, a streaming data server, or a combination of servers.

The computer 702 can receive requests over network 730 from a client application (for example, executing on another computer 702). The computer 702 can respond to the received requests by processing the received requests using software applications. Requests can also be sent to the computer 702 from internal users (for example, from a command console), external (or third) parties, automated applications, entities, individuals, systems, and computers.

Each of the components of the computer 702 can communicate using a system bus 803. In some implementations, any or all of the components of the computer 702, including hardware or software components, can interface with each other or the interface 704 (or a combination of both) over the system bus 803. Interfaces can use an application programming interface (API) 712, a service layer 713, or a combination of the API 712 and service layer 713. The API 712 can include specifications for routines, data structures, and object classes. The API 712 can be either computer-language independent or dependent. The API 712 can refer to a complete interface, a single function, or a set of APIs.

The service layer 713 can provide software services to the computer 702 and other components (whether illustrated or not) that are communicably coupled to the computer 702. The functionality of the computer 702 can be accessible for all service consumers using this service layer. Software services, such as those provided by the service layer 713, can provide reusable, defined functionalities through a defined interface. For example, the interface can be software written in JAVA, C++, or a language providing data in extensible markup language (XML) format. While illustrated as an integrated component of the computer 702, in alternative implementations, the API 712 or the service layer 713 can be stand-alone components in relation to other components of the computer 702 and other components communicably coupled to the computer 702. Moreover, any or all parts of the API 712 or the service layer 713 can be implemented as child or sub-modules of another software module, enterprise application, or hardware module without departing from the scope of the present disclosure.

The computer 702 includes an interface 704. Although illustrated as a single interface 704 in FIG. 7, two or more interfaces 704 can be used according to particular needs, desires, or particular implementations of the computer 702 and the described functionality. The interface 704 can be used by the computer 702 for communicating with other systems that are connected to the network 730 (whether illustrated or not) in a distributed environment. Generally, the interface 704 can include, or be implemented using, logic encoded in software or hardware (or a combination of software and hardware) operable to communicate with the network 730. More specifically, the interface 704 can include software supporting one or more communication protocols associated with communications. As such, the network 730 or the interface's hardware can be operable to communicate physical signals within and outside of the illustrated computer 702.

The computer 702 includes a processor 705. Although illustrated as a single processor 705 in FIG. 7, two or more processors 705 can be used according to particular needs, desires, or particular implementations of the computer 702 and the described functionality. Generally, the processor 705 can execute instructions and can manipulate data to perform the operations of the computer 702, including operations using algorithms, methods, functions, processes, flows, and procedures as described in the present disclosure.

The computer 702 also includes a database 706 that can hold data for the computer 702 and other components connected to the network 730 (whether illustrated or not). For example, database 706 can be an in-memory, conventional, or a database storing data consistent with the present disclosure. In some implementations, database 706 can be a combination of two or more different database types (for example, hybrid in-memory and conventional databases) according to particular needs, desires, or particular implementations of the computer 702 and the described functionality. Although illustrated as a single database 706 in FIG. 7, two or more databases (of the same, different, or combination of types) can be used according to particular needs, desires, or particular implementations of the computer 702 and the described functionality. While database 706 is illustrated as an internal component of the computer 702, in alternative implementations, database 706 can be external to the computer 702.

The computer 702 also includes a memory 707 that can hold data for the computer 702 or a combination of components connected to the network 730 (whether illustrated or not). Memory 707 can store any data consistent with the present disclosure. In some implementations, memory 707 can be a combination of two or more different types of memory (for example, a combination of semiconductor and magnetic storage) according to particular needs, desires, or particular implementations of the computer 702 and the described functionality. Although illustrated as a single memory 707 in FIG. 7, two or more memories 707 (of the same, different, or combination of types) can be used according to particular needs, desires, or particular implementations of the computer 702 and the described functionality. While memory 707 is illustrated as an internal component of the computer 702, in alternative implementations, memory 707 can be external to the computer 702.

The application 708 can be an algorithmic software engine providing functionality according to particular needs, desires, or particular implementations of the computer 702 and the described functionality. For example, application 708 can serve as one or more components, modules, or applications. Further, although illustrated as a single application 708, the application 708 can be implemented as multiple applications 708 on the computer 702. In addition, although illustrated as internal to the computer 702, in alternative implementations, the application 708 can be external to the computer 702.

The computer 702 can also include a power supply 714. The power supply 714 can include a rechargeable or non-rechargeable battery that can be configured to be either user- or non-user-replaceable. In some implementations, the power supply 714 can include power-conversion and management circuits, including recharging, standby, and power management functionalities. In some implementations, the power-supply 714 can include a power plug to allow the computer 702 to be plugged into a wall socket or a power source to, for example, power the computer 702 or recharge a rechargeable battery.

There can be any number of computers 702 associated with, or external to, a computer system containing computer 702, with each computer 702 communicating over network 730. Further, the terms “client,” “user,” and other appropriate terminology can be used interchangeably, as appropriate, without departing from the scope of the present disclosure. Moreover, the present disclosure contemplates that many users can use one computer 702 and one user can use multiple computers 702.

Described implementations of the subject matter can include one or more features, alone or in combination.

For example, in a first implementation, a computer-implemented method includes the following.

Example 1 is a carbon veil heating element integrated within layers of a multi-layer composite material without a discrete adhesive layer contacting the carbon veil heating element; a first busbar electrically coupled to the carbon veil heating element, and a second busbar electrically coupled to the carbon veil heating element, the first busbar and the second busbar configured to establish a voltage across the carbon veil heating element.

Example 2 may include the subject matter of example 1, and can also include a first structural layer formed by winding a resin-rich laminate reinforced with a glass surface veil, the carbon veil heating element formed above the first structural layer.

Example 3 may include the subject matter of example 2, where the carbon veil directly contacts the first structural element, the apparatus further including an insulating layer formed on the carbon veil heating element.

Example 4 may include the subject matter of example 2, further including an insulating layer formed between the first structural layer and the carbon veil heating element.

Example 5 may include the subject matter of example 4, wherein the insulating layer is a first insulating layer, the apparatus further including a second insulating layer formed on the carbon veil heating element.

Example 6 may include the subject matter of any of examples 1-5, wherein the apparatus includes a protection layer.

Example 7 may include the subject matter of example 1, further including a liner beneath the first structural layer.

Example 8 is a method for forming a non-metallic pipe with an integrated heating element, the method including: forming a first structural layer by fiber winding a resin-rich glass surface veil, the resin-rich glass surface veil including a curable wet resin; before the wet resin has cured, applying a carbon veil above the first structural layer; bonding a first busbar to a first edge of the carbon veil; bonding a second busbar to a second edge of the carbon veil, the first busbar configured to conduct electrical charge to the second busbar through the conductive veil; forming an insulating layer on the carbon veil; and forming a second structural layer on the insulating layer.

Example 9 may include the subject matter of example 8, wherein the insulating layer is a second insulating layer, the method further including, prior to applying the carbon veil, forming a first insulating layer on the first structural layer before the resin has cured.

Example 10 may include the subject matter of example 8, wherein the first structural layer includes a glass surface veil with a C-glass composition in a range from 25-35 grams/square meter.

Example 11 may include the subject matter of example 8, wherein the first structural layer includes a resin-rich laminate with a thickness in a range from 0.25 to 0.5 millimeters.

Example 12 may include the subject matter of example 8, further including forming a reinforced layer on the first structural layer prior to the resin curing, the reinforced layer including E-glass with a composition of 450 grams/square meter and with a resin content in a range from 60-80%.

Example 13 may include the subject matter of example 12, wherein the reinforced layer includes one of a chopped strand mat or tight weave glass fabric layer.

Example 14 may include the subject matter of any of examples 8-13, wherein the resin-rich corrosion protection layer includes a C-glass veil with a C-glass composition in the range of 25 to 35 grams per square meter.

Example 15 may include the subject matter of example 16, The method of claim 16, wherein the wet resin includes one of: a polyester resin based on bisphenol A or Isophthalic acid with temperature ranges from 50 to 75° C.; or a vinyl ester resin with temperature ranges from 75 to 100° C., or an epoxy resin with temperature ranges 80 to 200° C.

Example 16 may include the subject matter of any of examples 8-15, wherein the conductive carbon veil is wrapped in a spiral configuration.

Example 17 may include the subject matter of any of examples 8-16, wherein multiple conductive carbon veils are wrapped around the surface.

Example 18 may include the subject matter of any of examples 8-17, wherein first busbar is electrically connected to a power source and the second busbar is electrically connected to the power source, and wherein the conductive carbon veil is configured to pass current from the power supply from the first conductive strip to the second conductive strip.

Example 19 is a non-metallic composite hollow cylinder including: a first non-metallic structural layer; a carbon veil heating element formed above the first non-metallic layer, the carbon veil heating element including two electrodes; an insulating layer; and a second non-metallic structural layer; wherein the carbon veil heating element is bonded to the first non-metallic structural layer without an adhesive layer.

Example 20 may include the subject matter of claim 19, wherein the insulating layer is a first insulating layer and resides between the first non-metallic structural layer and the carbon veil; and the non-metallic composite pipe further including a second insulating layer formed between the carbon veil and the second non-metallic structural layer.

Example 21 may include the subject matter of any of examples 19-20, further including: a first busbar electrically coupled to a first edge of the carbon veil heating element; a second busbar electrically coupled to a second edge of the carbon veil heating element, the first edge opposite the second edge, the first busbar and the second busbar including a conductive material for establishing a voltage across the carbon veil heating element.

Example 22 may include the subject matter of any of examples 19-22, wherein the first non-metallic structural layer includes: a surface layer formed from a chemically resistant material; and a structural reinforcement layer.

Example 23 may include the subject matter of any of examples 19-22, wherein the insulating layer is an outer insulating layer that provides electrical insulation and strain relief for the carbon veil.

Example 24 may include the subject matter of example 23, further including an inner insulating layer formed between the carbon veil heating element and first non-metallic structural layer.

Example 25 may include the subject matter of example 23, further including a protective layer formed on the second non-metallic structural layer.

Example 26 may include the subject matter of any of examples 19-25, wherein the hollow cylinder is a pipe.

Example 27 may include the subject matter of any of examples 19-26, wherein the hollow cylinder forms a portion of a tank or boiler.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 702.11 a/b/g/n or 702.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. An apparatus comprising:
a carbon veil heating element integrated within layers of a multi-layer composite material without a discrete adhesive layer contacting the carbon veil heating element;
a first busbar electrically coupled to the carbon veil heating element, and,
a second busbar electrically coupled to the carbon veil heating element, the first busbar and the second busbar configured to establish a voltage across the carbon veil heating element.

2. The apparatus of claim 1, further comprising a first structural layer formed by winding a resin-rich laminate reinforced with a glass surface veil, the carbon veil heating element formed above the first structural layer.

3. The apparatus of claim 2, wherein the carbon veil directly contacts the first structural element, the apparatus further comprising an insulating layer formed on the carbon veil heating element.

4. The apparatus of claim 2, further comprising an insulating layer formed between the first structural layer and the carbon veil heating element.

5. The apparatus of claim 4, wherein the insulating layer is a first insulating layer, the apparatus further comprising a second insulating layer formed on the carbon veil heating element.

6. The apparatus of claim 1, wherein the apparatus comprises a protection layer.

7. The apparatus of claim 1, further comprising a liner beneath the first structural layer.

8. A method for forming a non-metallic pipe with an integrated heating element, the method comprising:
forming a first structural layer by fiber winding a resin-rich glass surface veil, the resin-rich glass surface veil comprising a curable wet resin;
before the wet resin has cured, applying a carbon veil above the first structural layer;
bonding a first busbar to a first edge of the carbon veil;
bonding a second busbar to a second edge of the carbon veil, the first busbar configured to conduct electrical charge to the second busbar through the conductive veil;
forming an insulating layer on the carbon veil; and
forming a second structural layer on the insulating layer.

9. The method of claim 8, wherein the insulating layer is a second insulating layer, the method further comprising, prior to applying the carbon veil, forming a first insulating layer on the first structural layer before the resin has cured.

10. The method of claim 8, wherein the first structural layer comprises a glass surface veil with a C-glass composition in a range from 25-35 grams/square meter.

11. The method of claim 8, wherein the first structural layer comprises a resin-rich laminate with a thickness in a range from 0.25 to 0.5 millimeters.

12. The method of claim 8, further comprising forming a reinforced layer on the first structural layer prior to the resin curing, the reinforced layer comprising E-glass with a composition of 450 grams/square meter and with a resin content in a range from 60-80%.

13. The method of claim 12, wherein the reinforced layer comprises one of a chopped strand mat or tight weave glass fabric layer.

14. The method of claim 8, wherein the resin-rich corrosion protection layer comprises a C-glass veil with a C-glass composition in the range of 25 to 35 grams per square meter.

15. The method of claim 8, wherein the wet resin comprises one of:
a polyester resin based on bisphenol A or Isophthalic acid with temperature ranges from 50 to 75° C.; or
a vinyl ester resin with temperature ranges from 75 to 100° C., or
an epoxy resin with temperature ranges 80 to 200° C.

16. The method of claim 8, wherein the conductive carbon veil is wrapped in a spiral configuration.

17. The method of claim 8, wherein multiple conductive carbon veils are wrapped around the surface.

18. The method of claim 8, wherein first busbar is electrically connected to a power source and the second busbar is electrically connected to the power source, and wherein the conductive carbon veil is configured to pass current from the power supply from the first conductive strip to the second conductive strip.

19. A non-metallic composite hollow cylinder comprising:
a first non-metallic structural layer;
a carbon veil heating element formed above the first non-metallic layer, the carbon veil heating element comprising two electrodes;
an insulating layer; and
a second non-metallic structural layer;
wherein the carbon veil heating element is bonded to the first non-metallic structural layer without an adhesive layer.

20. The non-conductive composite hollow cylinder of claim 19, wherein the insulating layer is a first insulating layer and resides between the first non-metallic structural layer and the carbon veil; and
the non-metallic composite pipe further comprising a second insulating layer formed between the carbon veil and the second non-metallic structural layer.

21. The non-conductive composite hollow cylinder of claim 19, further comprising:
a first busbar electrically coupled to a first edge of the carbon veil heating element;
a second busbar electrically coupled to a second edge of the carbon veil heating element, the first edge opposite the second edge,
the first busbar and the second busbar comprising a conductive material for establishing a voltage across the carbon veil heating element.

22. The non-conductive composite hollow cylinder of claim 19, wherein the first non-metallic structural layer comprises:
a surface layer formed from a chemically resistant material; and
a structural reinforcement layer.

23. The non-conductive composite hollow cylinder of claim 19, wherein the insulating layer is an outer insulating layer that provides electrical insulation and strain relief for the carbon veil.

24. The non-conductive composite hollow cylinder of claim 23, further comprising an inner insulating layer formed between the carbon veil heating element and first non-metallic structural layer.

25. The non-conductive composite hollow cylinder of claim 23, further comprising a protective layer formed on the second non-metallic structural layer.

26. The non-conductive composite hollow cylinder of claim 19, wherein the hollow cylinder is a pipe.

27. The non-conductive composite hollow cylinder of claim 19, wherein the hollow cylinder forms a portion of a tank or boiler.
